(19) United States
(12) Patent Application Publication
(10) Pub. No.: US 2025/0321960 A1
(43) Pub. Date: Oct. 16, 2025

(54) PERFORMING DATA JOIN OPERATIONS UTILIZING PROBABILISTIC DATA STRUCTURES

(71) Applicant: Dell Products L.P., Round Rock, TX (US)

(72) Inventors: Derek OKeeffe, Cork (IE); Lucia Brunetti, Limerick (IE); Yassir Houreh, Cork (IE)

(21) Appl. No.: 18/633,774

(22) Filed: Apr. 12, 2024

(51) Int. Cl. G06F 16/2453

(52) U.S. Cl. CPC G06F 16/24537

(57) ABSTRACT

An apparatus comprises at least one processing device configured to receive, at a first compute node from a client, a request to perform a data join operation involving first and second data sets maintained in first and second data stores managed by the first compute node and a second compute node, respectively. The at least one processing device is also configured to obtain, at the first compute node from the second compute node, a probabilistic data structure representing content of the second data set. The at least one processing device is also configured to generate, by the first compute node, a third data set by applying the probabilistic data structure to the first data set, the third data set comprising a subset of elements of the first data set, and to provide, from the first compute node to the client, the third data set.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

As the value and use of information continues to increase, individuals and businesses seek additional ways to process and store information. Information processing systems may be used to process, compile, store and communicate various types of information. Because technology and information processing needs and requirements vary between different users or applications, information processing systems may also vary (e.g., in what information is processed, how the information is processed, how much information is processed, stored, or communicated, how quickly and efficiently the information may be processed, stored, or communicated, etc.). Information processing systems may be configured as general purpose, or as special purpose configured for one or more specific users or use cases (e.g., financial transaction processing, airline reservations, enterprise data storage, global communications, etc.). Information processing systems may include a variety of hardware and software components that may be configured to process, store, and communicate information and may include one or more computer systems, data storage systems, and networking systems.

### SUMMARY

Illustrative embodiments of the present disclosure provide techniques for performing data join operations utilizing probabilistic data structures.

In one embodiment, an apparatus comprises at least one processing device comprising a processor coupled to a memory. The at least one processing device is configured to receive, at a first compute node from a client, a request to perform a data join operation involving a first data set and a second data set, wherein the first data set is maintained in a first data store managed by the first compute node and the second data set is maintained in a second data store managed by a second compute node. The at least one processing device is also configured to obtain, at the first compute node from the second compute node, a probabilistic data structure representing content of the second data set. The at least one processing device is further configured to generate, by the first compute node, a third data set by applying the probabilistic data structure to the first data set, the third data set comprising a subset of elements of the first data set, and to provide, from the first compute node to the client, the third data set.

These and other illustrative embodiments include, without limitation, methods, apparatus, networks, systems and processor-readable storage media.

### BRIEF DESCRIPTION OF THE DRAWINGS

FIG. 1 is a block diagram of an information processing system configured for performing data join operations utilizing probabilistic data structures in an illustrative embodiment.

FIG. 2 is a flow diagram of an exemplary process for performing data join operations utilizing probabilistic data structures in an illustrative embodiment.

FIGS. 3A and 3B show a join operation for data sets associated with discrete microservices in an illustrative embodiment.

FIG. 4 shows a process flow for performing a join operation for data sets associated with discrete microservices in an illustrative embodiment.

FIGS. 5A and 5B show pseudocode for performing a join operation for data sets associated with discrete microservices in an illustrative embodiment.

FIGS. 6 and 7 show examples of processing platforms that may be utilized to implement at least a portion of an information processing system in illustrative embodiments.

### DETAILED DESCRIPTION

Illustrative embodiments will be described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other type of cloud-based system that includes one or more clouds hosting tenants that access cloud resources.

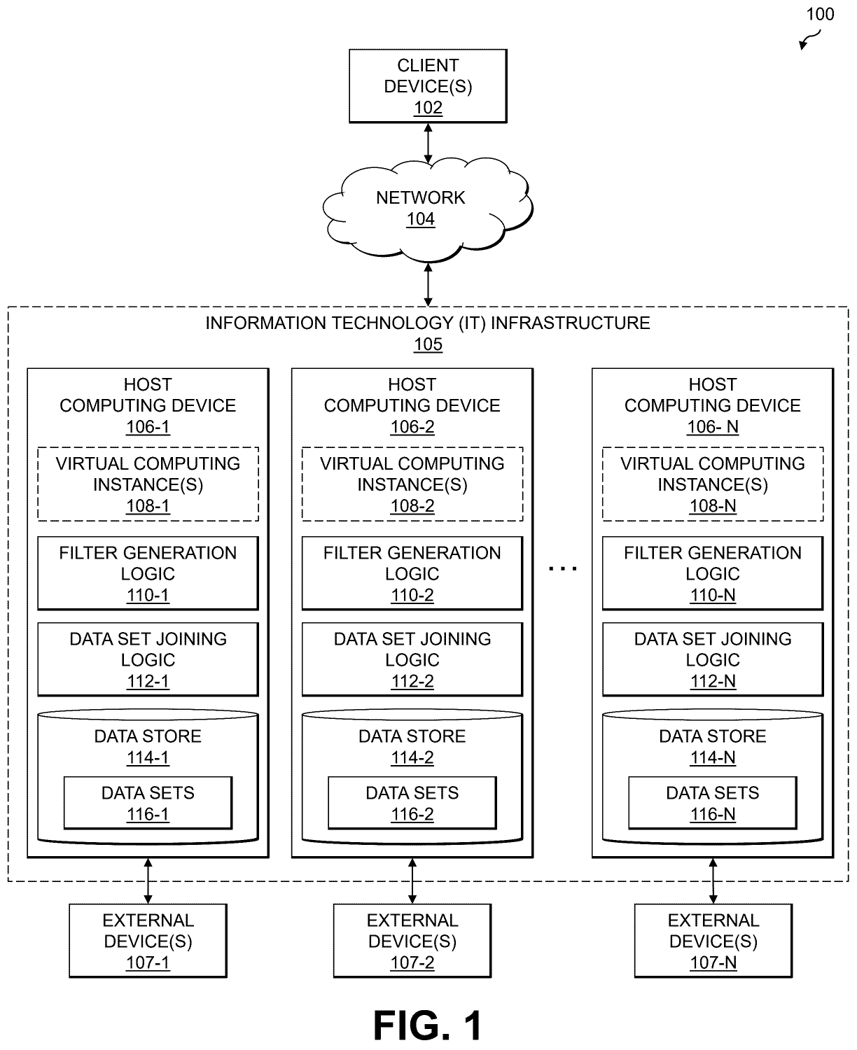

FIG. 1 shows an information processing system 100 configured in accordance with an illustrative embodiment. The information processing system 100 is assumed to be built on at least one processing platform and provides functionality for performing data join operations utilizing probabilistic data structures. A probabilistic data structure, as used herein, refers to a data structure such as a filter (e.g., a Bloom filter) that characterizes content of a data set, with the probabilistic data structure being utilizable for determining, with a configurable false positivity rate, whether a particular element is a member of the data set. The information processing system 100 includes one or more client devices 102 which are coupled to a network 104. Also coupled to the network 104 is an information technology (IT) infrastructure 105 (e.g., an edge or other data center) comprising host computing devices 106-1, 106-2, . . . 106-N(collectively, host computing devices 106) which are connected to respective sets of one or more external devices 107-1, 107-2, . . . 107-N (collectively, external devices 107). The host computing devices 106 are examples of assets of the IT infrastructure 105, and thus may be referred to as IT assets. The host computing devices 106 are also examples of what is more generally referred to herein as compute nodes, though a wide variety of other compute nodes can be used. The host computing devices 106 may include physical hardware such as servers, storage systems, networking equipment, and other types of processing and computing devices. The external devices 107 may comprise sensor devices such as Internet of Things (IoT) devices, peripherals, etc. which are connected to the host computing devices 106. The host computing devices 106-1, 106-2, . . . 106-N may run one or more virtual computing instances 108-1, 108-2, . . . 108-N(collectively, virtual computing instances 108). The virtual computing instances 108 may comprise, for example, virtual machines (VMs), containers, microservices, etc.

In some embodiments, the IT infrastructure 105 is used by, or is part of, an enterprise system. For example, an enterprise may utilize the host computing devices 106 of the IT infrastructure 105 for offering one or more services or functionality for end-users (e.g., associated with the client devices 102. Users of the enterprise (e.g., support technicians, field engineers or other employees, customers or users, etc.) which are associated with the one or more client devices 102 may utilize the IT infrastructure 105 to perform various operations, which include but are not limited to querying information that is stored across multiple ones of the host computing devices 106, such as portions of one or more of data sets 116-1, 116-2, . . . 116-N(collectively, data sets 116) stored on respective distinct data stores 114-1, 114-2, . . . 114-N(collectively, data stores 114) associated with different ones of the host computing devices 106. In some embodiments, at least one of the host computing devices 106 is assumed to run multiple virtual computing instances 108 (e.g., multiple microservices). In such cases, each of the multiple virtual computing instances 108 may be associated with a discrete or distinct data store that is not accessible to other ones of the multiple virtual computing instances 108 running on that host computing device 106. Thus, a data join operation may in some cases be performed internal to a single one of the host computing devices 106 based on distinct data sets which are stored in distinct data stores managed by different ones of the virtual computing instances 108 running on that one of the host computing devices 106.

As used herein, the term “enterprise system” is intended to be construed broadly to include any group of systems or other computing devices. For example, the IT infrastructure 105 may provide a portion of one or more enterprise systems. A given enterprise system may also or alternatively include the one or more client devices 102. In some embodiments, an enterprise system includes one or more data centers, cloud infrastructure comprising one or more clouds, etc. A given enterprise system, such as cloud infrastructure, may host assets that are associated with multiple enterprises (e.g., two or more different businesses, organizations or other entities).

The client devices 102 may comprise, for example, physical computing devices such as mobile telephones, laptop computers, tablet computers, or other types of devices utilized by one or more members of an enterprise, in any combination. Such devices are examples of what are more generally referred to herein as “processing devices.” Some of these processing devices are also generally referred to herein as “computers.”

The client devices 102 in some embodiments comprise computers associated with a particular company, organization or other enterprise. Thus, the client devices 102 may be considered examples of assets of an enterprise system. In addition, at least portions of the information processing system 100 may also be referred to herein as collectively comprising one or more “enterprises.” Numerous other operating scenarios involving a wide variety of different types and arrangements of processing nodes are possible, as will be appreciated by those skilled in the art.

The network 104 is assumed to comprise a global computer network such as the Internet, although other types of networks can be part of the network 104, including a wide area network (WAN), a local area network (LAN), a satellite network, a telephone or cable network, a cellular network, a wireless network such as a WiFi or WiMAX network, or various portions or combinations of these and other types of networks.

Although not explicitly shown in FIG. 1, one or more input-output devices such as keyboards, displays or other types of input-output devices may be used to support one or more user interfaces to the client devices 102 and/or the host computing devices 106 of the IT infrastructure 105, as well as to support communication between these components and other related systems and devices not explicitly shown.

The client devices 102 and the host computing devices 106 in the FIG. 1 embodiment are each assumed to be implemented using at least one processing device. Each such processing device generally comprises at least one processor and an associated memory, and implements one or more functional modules or logic for controlling certain features of the client devices 102 and the host computing devices 106. In the FIG. 1 embodiment, the host computing devices 106 implement respective instances of filter generation logic 110-1, 110-2, . . . 110-N(collectively, filter generation logic 110) and data set joining logic 112-1, 112-2, . . . 112-N(collectively, data set joining logic 112). The host computing devices 106, as discussed above, are also associated with distinct data stores 114 storing data sets 116. In some embodiments, one or more storage systems utilized to implement the data stores 114 comprise one or more scale-out all-flash content addressable storage arrays or other types of storage arrays. Various other types of storage systems may be used, and the term “storage system” as used herein is intended to be broadly construed, and should not be viewed as being limited to content addressable storage systems or flash-based storage systems. A given storage system as the term is broadly used herein can comprise, for example, network-attached storage (NAS), storage area networks (SANs), direct-attached storage (DAS) and distributed DAS, as well as combinations of these and other storage types, including software-defined storage. Other particular types of storage products that can be used in implementing storage systems in illustrative embodiments include all-flash and hybrid flash storage arrays, software-defined storage products, cloud storage products, object-based storage products, and scale-out NAS clusters. Combinations of multiple ones of these and other storage products can also be used in implementing a given storage system in an illustrative embodiment.

The host computing devices 106 are configured to utilize the filter generation logic 110 to generate filters (e.g., Bloom filter data structures) that may be used to facilitate performance of join operations utilizing the data set joining logic 112. Consider, for example, a first microservice (running as one of the virtual computing instances 108-1 on the host computing device 106-1) and a second microservice (running as one of the virtual computing instances 108-2 on the host computing device 106-2). The first and second microservices have access to distinct data sets 116-1 and 116-2 in the data stores 114-1 and 114-2. One or more of the client devices 102 may send a query to one of the first and second microservices to perform a join operation involving at least a portion of the data sets 116-1 and 116-2. The join operation may be a “left exclusion” join (e.g., where it is desired to determine members or entries of the data set 116-1 which are not members or entries of the data set 116-2). To process this join operation, the first microservice utilizes the filter generation logic 110-1 to request the second microservice to generate a filter based on the data sets 116-2. The second microservice utilizes the filter generation logic 110-2 to generate the requested filter, which is then returned to the first microservice. The first microservice then utilizes the data set joining logic 112-1 to perform the join operation by filtering the data sets 116-1 utilizing the filter received from the second microservice. Various other types of join operations may be performed utilizing filters generated as described above and elsewhere herein.

At least portions of the virtual computing instances 108, the filter generation logic 110 and the data set joining logic 112 may be implemented at least in part in the form of software that is stored in memory and executed by a processor.

In some embodiments, the client devices 102 and the host computing devices 106 of the IT infrastructure 105 implement host agents that are configured for exchanging information with one another (e.g., requests and responses associated with join operations performed utilizing the data sets 116). It should be noted that a “host agent” as this term is generally used herein may comprise an automated entity, such as a software entity running on a processing device. Accordingly, a host agent need not be a human entity.

The IT infrastructure 105 and other portions of the information processing system 100, as will be described in further detail below, may be part of cloud infrastructure.

The IT infrastructure 105 and other components of the information processing system 100 in the FIG. 1 embodiment are assumed to be implemented using at least one processing platform comprising one or more processing devices each having a processor coupled to a memory. Such processing devices can illustratively include particular arrangements of compute, storage and network resources.

The client devices 102, the IT infrastructure 105, the host computing devices 106, and the external devices 107 or components thereof (e.g., virtual computing instances 108, the filter generation logic 110, the data set joining logic 112 and the data stores 114) may be implemented on respective distinct processing platforms, although numerous other arrangements are possible. For example, in some embodiments at least portions of one or more of the client devices 102, the IT infrastructure 105 and/or the host computing devices 106 are implemented on the same processing platform. The client devices 102 can therefore be implemented at least in part within at least one processing platform that implements at least a portion of the IT infrastructure 105.

The term “processing platform” as used herein is intended to be broadly construed so as to encompass, by way of illustration and without limitation, multiple sets of processing devices and associated storage systems that are configured to communicate over one or more networks. For example, distributed implementations of the information processing system 100 are possible, in which certain components of the system reside in one data center in a first geographic location while other components of the system reside in one or more other data centers in one or more other geographic locations that are potentially remote from the first geographic location. Thus, it is possible in some implementations of the information processing system 100 for the client devices 102, the IT infrastructure 105, the host computing devices 106, the external devices 107, and the data stores 114, or portions or components thereof, to reside in different data centers. Numerous other distributed implementations are possible. The IT infrastructure 105 can also be implemented in a distributed manner across multiple data centers.

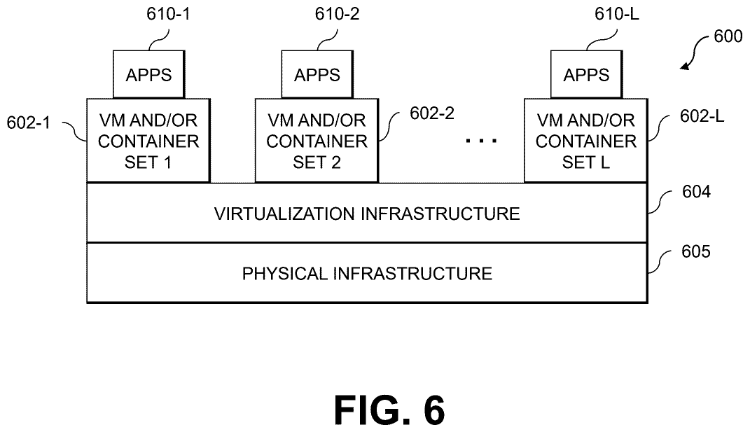

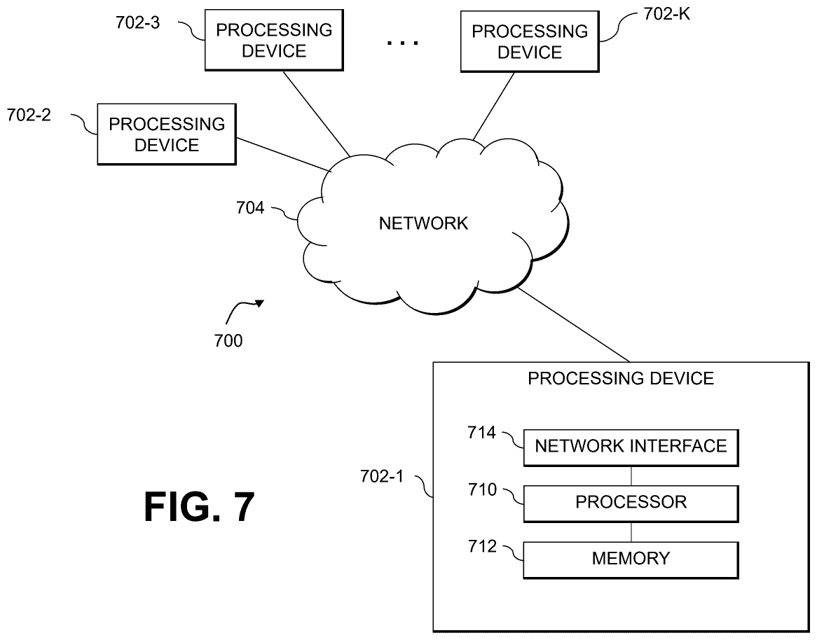

Additional examples of processing platforms utilized to implement the IT infrastructure 105 and other components of the information processing system 100 in illustrative embodiments will be described in more detail below in conjunction with FIGS. 6 and 7.

It is to be appreciated that these and other features of illustrative embodiments are presented by way of example only, and should not be construed as limiting in any way.

It is to be understood that the particular set of elements shown in FIG. 1 for performing data join operations utilizing probabilistic data structures is presented by way of illustrative example only, and in other embodiments additional or alternative elements may be used. Thus, another embodiment may include additional or alternative systems, devices and other network entities, as well as different arrangements of modules and other components.

It is to be appreciated that these and other features of illustrative embodiments are presented by way of example only, and should not be construed as limiting in any way.

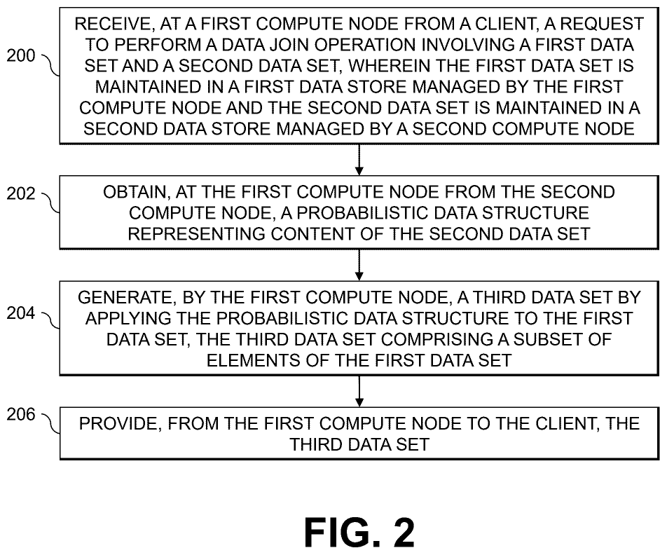

An exemplary process for performing data join operations utilizing probabilistic data structures will now be described in more detail with reference to the flow diagram of FIG. 2. It is to be understood that this particular process is only an example, and that additional or alternative processes for performing data join operations utilizing probabilistic data structures may be used in other embodiments.

In this embodiment, the process includes steps 200 through 206. These steps are assumed to be performed by the one or more of the host computing devices 106 of the IT infrastructure 105 utilizing the filter generation logic 110 and data set joining logic 112. The process begins with step 200, receiving at a first compute node (e.g., host computing device 106-1) from a client (e.g., one of the client devices 102), a request to perform a data join operation involving a first data set (e.g., one of data sets 116-1) and a second data set (e.g., one of data sets 116-2), where the first data set is maintained in a first data store (e.g., data store 114-1) managed by the first compute node and the second data set is maintained in a second data store (e.g., data store 114-2) managed by a second compute node. The data join operation may be an exclusion join operation comprising a request for elements of the first data set which are not elements of the second data set. The first compute node may be a first virtual computing instance (e.g., one of the virtual computing instances 108-1) and the second compute node may be a second virtual computing instance (e.g., one of the virtual computing instances 108-2). The first compute node may comprise a first microservice and the second compute node may comprise a second microservice.

In step 202, a probabilistic data structure representing content of the second data set is obtained at the first compute node from the second compute node. The probabilistic data structure representing the content of the second data set may comprise a filter, such as a Bloom filter. The probabilistic data structure may be associated with a configurable false positive probability rate. Step 202 may include providing, from the first compute node to the second compute node, a value for the configurable false positive probability rate. The value for the configurable false positive probability rate may be specified in the request to perform the data join operation received from the client in step 200. In some embodiments, step 202 includes receiving, at the first compute node from the second compute node, a serialized data structure, and deserializing, at the first compute node, the serialized data structure to obtain the probabilistic data structure. In some embodiments, step 202 may also or alternatively include providing, from the first compute node to the second compute node, a hypertext transfer protocol (HTTP) get request specifying join criteria for the data join operation and receiving, at the first compute node from the second compute node, an HTTP response comprising the probabilistic data structure.

In step 204, a third data set is generated by the first compute node by applying the probabilistic data structure to the first data set, the third data set comprising a subset of elements of the first data set. The subset of elements of the first data set which are included in the third data set may comprise the elements of the first data set which are determined, via application of the probabilistic data structure, to not be elements of the second data set.

In step 206, the third data set is provided from the first compute node to the client. In some embodiments, the first data set comprises an inventory of IT assets in an IT infrastructure which are eligible for a given software update, the second data set comprises a first subset of the IT assets in the IT infrastructure which have already been notified of availability of the given software update, and the third data set comprises a second subset of the IT assets in the IT infrastructure which are to be notified of the availability of the given software update.

The particular processing operations and other system functionality described in conjunction with the flow diagram of FIG. 2 are presented by way of illustrative example only, and should not be construed as limiting the scope of the disclosure in any way. Alternative embodiments can use other types of processing operations. For example, as indicated above, the ordering of the process steps may be varied in other embodiments, or certain steps may be performed at least in part concurrently with one another rather than serially. Also, one or more of the process steps may be repeated periodically, or multiple instances of the process can be performed in parallel with one another in order to implement a plurality of different processes for different data join operations, etc.

Functionality such as that described in conjunction with the flow diagram of FIG. 2 can be implemented at least in part in the form of one or more software programs stored in memory and executed by a processor of a processing device such as a computer or server. As will be described below, a memory or other storage device having executable program code of one or more software programs embodied therein is an example of what is more generally referred to herein as a “processor-readable storage medium.”

Microservices are small, independent and modular software components that perform a specific business or other function within a larger application. Microservices may be developed according to principles which discourage a shared persistence store (e.g., a database) across microservices. Querying and joining data across microservices for online transaction processing (OLTP) applications can sometimes be problematic in terms of performance and scalability depending on design decisions and data access patterns. These issues are usually not applicable to online analytical processing (OLAP) applications or legacy monolithic applications, as in these cases the compute and input-output (IO) overhead of the join is offloaded to a data store.

Illustrative embodiments provide technical solutions for enabling efficient join operations for data that is stored across multiple IT assets, such as data that is stored across multiple microservices or other virtual computing instances. The technical solutions are well-suited for IT infrastructure environments in which discrete IT assets (e.g., microservices) have their own data stores which are not shared, and where an access pattern requires one or more specific types of join operations on multiple datasets stored in the different data stores.

One conventional approach for performing join operations on data stored by discrete IT assets (e.g., microservices) requires the discrete IT assets to share their data via one or more application programming interfaces (APIs). For example, one or more Representational State Transfer (REST) APIs, may be used which provide an architectural style for designing network applications utilizing Hypertext Transfer Protocol (HTTP). Subsequently, one of the discrete IT assets performs the join operation in memory. This and other conventional approaches, however, suffer from various technical challenges related to performance and scalability when dealing with larger datasets. The technical solutions described herein overcome these and other technical challenges, through a scalable approach that provides excellent performance characteristics at a small cost in consistency.

In some embodiments, the technical solutions are utilized for data access patterns where a small cost in consistency is acceptable. In modern distributed systems which operate with an eventually consistent model, a small cost in consistency is usually not a problem. For example, the technical solutions may be implemented with a common update platform (CUP) application which determines where to push update notifications to a set of managed IT assets. The CUP is an application built by Dell services to enable, among other functionality, a common mechanism for pushing software and firmware updates to IT assets (e.g., including IT infrastructure products such as storage arrays, servers, data protection products, etc.). The technical solutions, however, are not limited to this use case and are more generally applicable across the wider industry including in IT infrastructures which utilize microservices and eventual-consistency architecture models. For example, the technical solutions may be implemented in various data management use cases, including for cloud solutions and managed services. For microservice-based cloud native applications with discrete data stores, some data access patterns may require exclusion-joining of data across multiple microservices. When datasets become large, conventional approaches for handling such data access patterns do not scale.

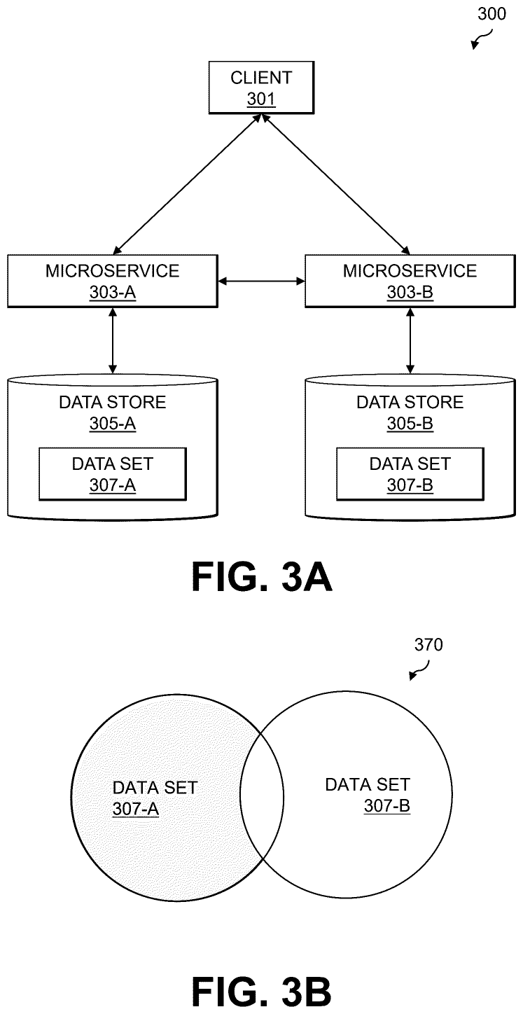

FIG. 3A shows a system 300 including a client 301 and microservices 303-A and 303-B (collectively, microservices 303). The microservice 303-A is associated with a data store 305-A in which a data set 307-A is stored, and the microservice 303-B is associated with a data store 305-B in which a data set 307-B is stored. The data stores 305-A and 305-B are collectively referred to as data stores 305, and the data sets 307-A and 307-B are collectively referred to as data sets 307. FIG. 3B shows a visualization of a join operation 370 for which the technical solutions described herein provide improved performance characteristics at a small cost in consistency. The join operation 370, which may be referred to as a left exclusion join, is a data join where the required data is the data set 307-A excluding members that are in the data set 307-B.

In some embodiments, the technical solutions use Bloom filters to represent the set that is to be excluded (e.g., the data set 307-B in the join operation 370). A Bloom filter is a space efficient probabilistic data structure for testing set inclusion (e.g., membership testing). The Bloom filter efficiently determines whether an element is a member of a set or not, with a small probability of false positives. If the Bloom filter returns that an element is not part of the set it is guaranteed to be accurate. If the Bloom filter reports that an element is part of the set, there is a small probability that this is a false positive. The false positive probability (fpp) value can be tuned. Depending on the fpp value, Bloom filters are typically orders of magnitude smaller than the entire set they represent. Bloom filters may be used in databases and caches, and some database types such as Postgres even support a Bloom index type natively. The technical solutions use Bloom filters, transported via HTTP (e.g., using one or more REST APIs) between the microservices 303-A and 303-B, to enable exclusion-joining capabilities (e.g., for the join operation 370).

It should be noted that while various embodiments are described with respect to performing an exclusion join of two data sets (e.g., the join operation 370 illustrated in FIG. 3B), the technical solutions may be more widely applicable to various other types of join operations. For example, an exclusion join of three or more data sets may be achieved through running multiple instances of the join operation 370 (e.g., for excluding data from data set 307-B from the data set 307-A to produce a first filtered data set, and then for excluding data from an additional data set from the first filtered data set). Various other examples are possible.

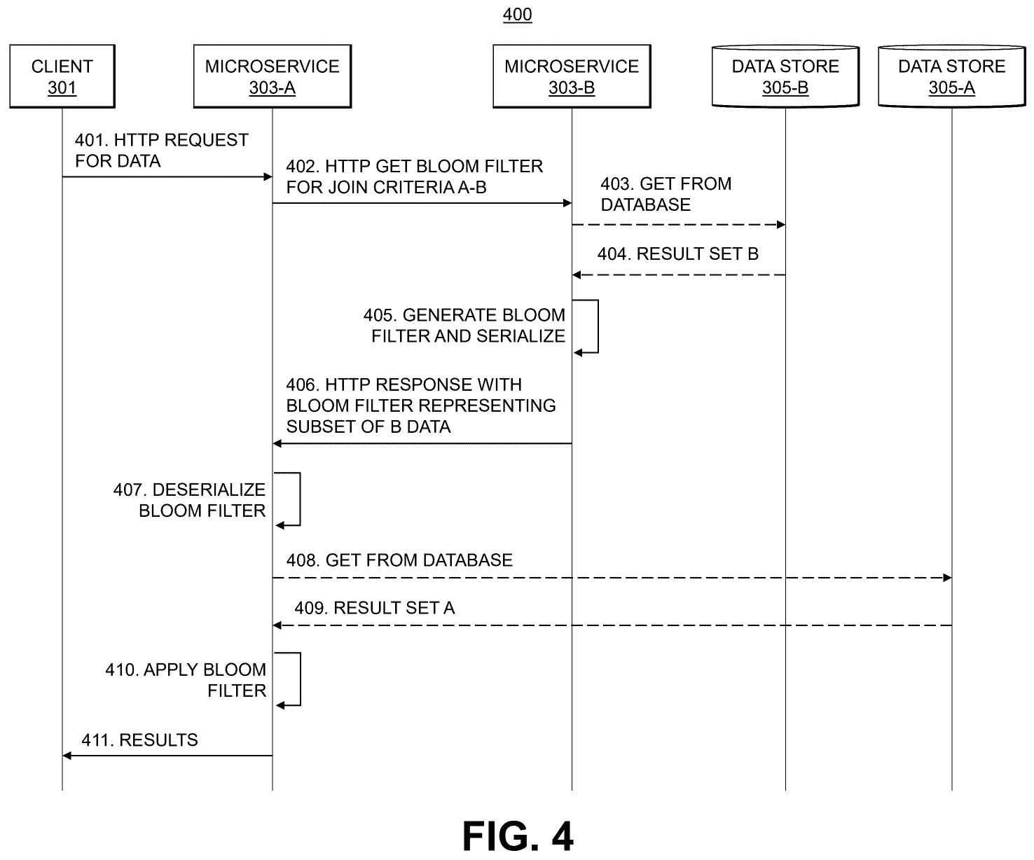

FIG. 4 shows a system flow 400 which may be performed in the system 300. In step 401, the client 301 requests data from the microservice 303-A (e.g., via an HTTP request). The microservice 303-A has the data needed (e.g., in the data set 307-A) from its associated data store 305-A, but needs to exclude some of the elements in the data set 307-A based on data (e.g., from the data set 307-B) stored in the data store 305-B associated with microservice 303-B. In step 402, the microservice 303-A requests a Bloom filter from the microservice 303-B (e.g., via an HTTP GET request), passing the join criteria (A-B) as arguments. In step 403, the microservice 303-B gets the data from its data store 305-B. In step 405, a result set B is provided to the microservice 303-B. In step 405, the microservice 303-B generates a Bloom filter representing the result set B and serializes it. In step 406, the microservice 303-B provides the serialized Bloom filter to the microservice 303-A (e.g., in an HTTP response). In step 407, the microservice 303-A deserializes the Bloom filter. In step 408, the microservice 303-A gets the data from its data store 305-A. In step 409, a result set A is provided to the microservice 303-A. In step 410, the microservice 303-A applies the Bloom filter to the result set A, to exclude any data that the Bloom filter indicates is “most likely” in the result set B. As discussed above, the technical solutions described herein have a small cost in consistency. Bloom filters have a configurable false positive rate for set inclusion, so there is a known and configurable probability that a test for inclusion will return a false positive. In practice, as datasets change, the probability of the same element being a false positive repeatedly tends towards zero. Thus, when the technical solutions are used for systems with eventual consistency this is not a major problem. The Bloom filter may be applied page by page, or may stream all the data back as needed. Since the Bloom filter is relatively small, it can be cached in the microservice 303-A for subsequent calls which use the same join criteria (e.g., in paged data requests). In step 411, the microservice 303-A returns results to the client 301 (e.g., in an HTTP response).

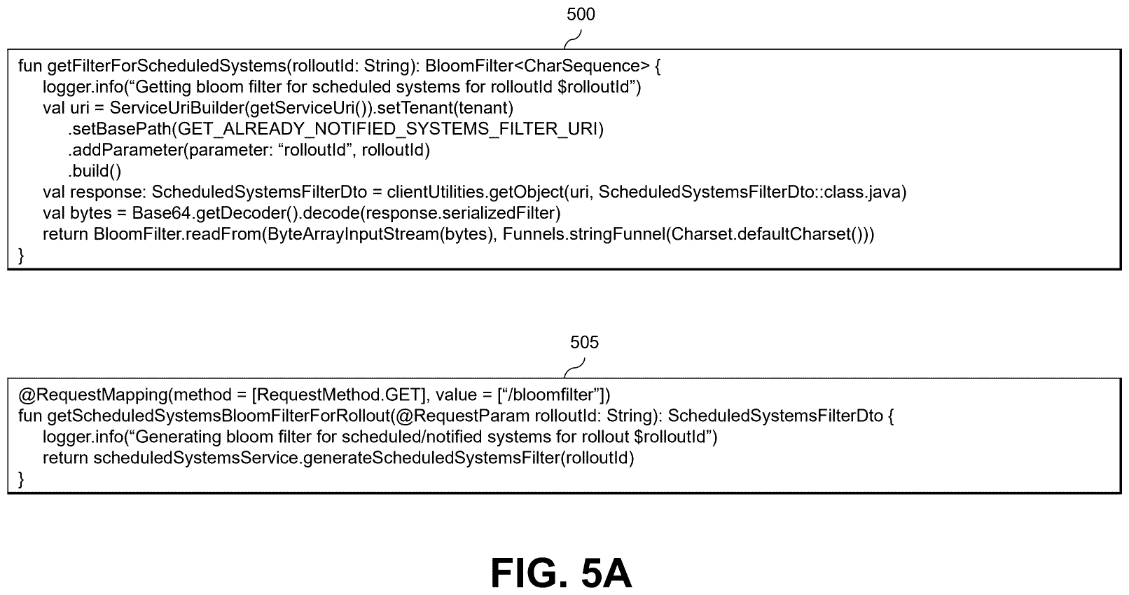

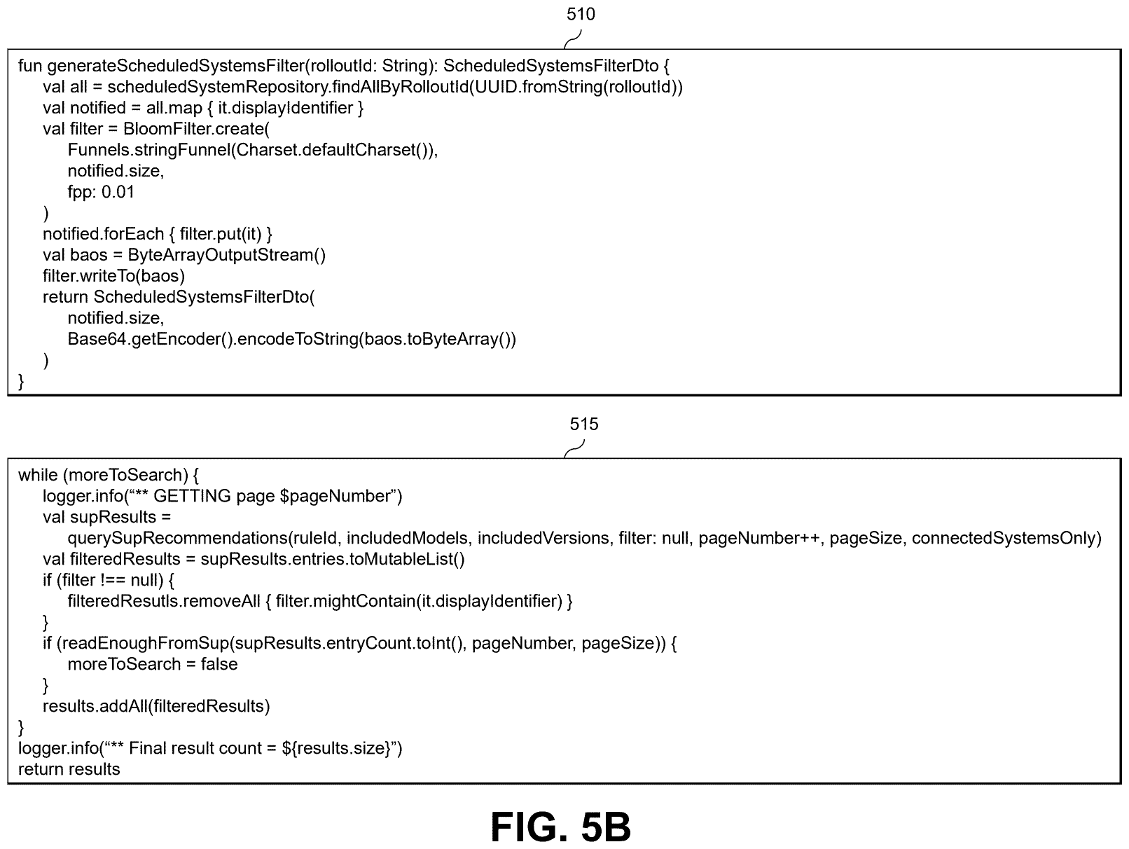

An example implementation of the system flow 400 will now be described with respect to use of the CUP tool. FIGS. 5A and 5B show pseudocode 500, 505, 510 and 515 from a CUP codebase written in Kotlin. The CUP tool is responsible for pushing software and firmware updates to IT assets. To do this, the CUP tool needs to know which of the IT assets it (most likely) has already notified for a given update. The dataset of possible updateable IT assets and the dataset of notified IT assets for a given update can be quite large, and are managed by two different microservices. As the rollout of a software update progresses over time, a user of the CUP tool can visually see how many IT assets have been notified and how many are pending. The CUP tool may provide one or more APIs for responding quickly to provide an acceptable user experience.

Pseudocode 500 shown in FIG. 5A illustrates functionality for the microservice 303-A to request a Bloom filter from the microservice 303-B. To provide the API for this use case, the microservice 303-A needs to get the details of already-notified IT assets from the microservice 303-B. This is performed via a REST API call to the microservice 303-B. The pseudocode 500 shows code for the REST API call and deserialization of the Bloom filter. In this case, the join criteria between the two datasets (data set 307-A and data set 307-B) is “rolloutId” which is passed as a parameter in the API call to the microservice 303-B. The response is serialized as a “BloomFilter” instance. In the example pseudocode 500 shown in FIG. 5A, the guava library is used for implementing the Bloom filter, though other implementations are possible.

Pseudocode 505 shown in FIG. 5A illustrates functionality for the microservice 303-B to generate the requested Bloom filter, and includes a request handler.

Pseudocode 510 shown in FIG. 5B illustrates a service layer which builds the requested Bloom filter. In the example pseudocode 510 shown in FIG. 5B, the fpp value is set to 0.01. This is acceptable in this use case, as the effects of a false positive are negated by an eventually consistent architecture. As a rollout proceeds over time, it is extremely unlikely that the same IT asset becomes a false positive repeatedly, thereby negating the effects of false positives. What this means is, if an IT asset missed getting an update at a first point in time, it is highly likely to get it at one or more subsequent points in time. In this example, the CUP tool is assumed to push updates to systems in batches at periodic intervals (e.g., every 5 minutes), so the system will become consistent in a brief time.

Pseudocode 515 shown in FIG. 5B illustrates functionality for the microservice 303-A to apply the Bloom filter to its data set (e.g., data set 307-A). Here, the Bloom filter is used to remove entries from the set called “filteredResults” when they match on “displayIdentifier.”

The pseudocode 500, 505, 510 and 515 shown in FIGS. 5A and 5B was tested with a set of 1,000,000 random universally unique identifiers (UUIDs) for IT assets. The Javascript Object Notation (JSON) serialization is compared to generation of a Bloom filter, with tests being run on a laptop with a single thread. JSON is a lightweight, text-based data interchange format used for data representation and exchange on the web. JSON uses key-value pairs and structured data, making it easy for humans to read and write, and for machines to parse and generate. JSON may be used for transmitting data between a server and a web application, and is thus commonly used in modern web development and APIs. JSON may thus be used for communication of data sets among microservices (e.g., such as transmitting the result set B from the microservice 303-B to the microservice 303-A). JSON serialization of the set took 232 milliseconds (ms), and Bloom filter generation took 914 ms. The Bloom filter generation was thus approximately four times slower than plain serialization. However, the Bloom filter was 1179 kilobytes (KB) in size, which was approximately thirty-two times smaller than the JSON as binary data at 38,085 KB. This means that the Bloom filter should transfer over a network approximately thirty-two times faster. In real world use cases, the JSON data would most likely be retrieved in pages so the real IO overhead of transferring all the data (e.g., the entire result set B from the microservice 303-B to the microservice 303-A) could be much larger.

The technical solutions described herein advantageously utilize a probabilistic data structure (e.g., a Bloom filter) transported (e.g., using HTTP and REST APIs) between microservices or other IT assets associated with discrete data stores, enabling low-compute and low-memory footprint for cross joining of data sets. Conventional approaches suffer from various technical problems. For example, direct queries via REST APIs involve transferring a complete set of information between microservices, which may work well for small and medium data sets, or where the data is static as caching can be used to alleviate performance problems. However, for large data sets such conventional approaches do not perform well (e.g., as in the experimental test described above, where the JSON binary data was thirty-two times larger than a Bloom filter, thus necessitating significantly more bandwidth and other resources). Other conventional approaches may rely on replication of data, using database tooling, between microservices. Such conventional approaches can leverage database capabilities and, if the data is indexed appropriately, can provide good performance characteristics. These conventional approaches, however, increase coupling between microservices making a continuous integration/continuous deployment (CI/CD) deployment difficult to implement. CI/CD is a software development practice that entails the continuous integration of code changes, followed by automated build, test and deployment processes to deliver software to production.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

Illustrative embodiments of processing platforms utilized to implement functionality for performing data join operations utilizing probabilistic data structures will now be described in greater detail with reference to FIGS. 6 and 7. Although described in the context of system 100, these platforms may also be used to implement at least portions of other information processing systems in other embodiments.

FIG. 6 shows an example processing platform comprising cloud infrastructure 600. The cloud infrastructure 600 comprises a combination of physical and virtual processing resources that may be utilized to implement at least a portion of the information processing system 100 in FIG. 1. The cloud infrastructure 600 comprises multiple virtual machines (VMs) and/or container sets 602-1, 602-2, . . . 602-L implemented using virtualization infrastructure 604. The virtualization infrastructure 604 runs on physical infrastructure 605, and illustratively comprises one or more hypervisors and/or operating system level virtualization infrastructure. The operating system level virtualization infrastructure illustratively comprises kernel control groups of a Linux operating system or other type of operating system.

The cloud infrastructure 600 further comprises sets of applications 610-1, 610-2, . . . 610-L running on respective ones of the VMs/container sets 602-1, 602-2, . . . 602-L under the control of the virtualization infrastructure 604. The VMs/container sets 602 may comprise respective VMs, respective sets of one or more containers, or respective sets of one or more containers running in VMs.

In some implementations of the FIG. 6 embodiment, the VMs/container sets 602 comprise respective VMs implemented using virtualization infrastructure 604 that comprises at least one hypervisor. A hypervisor platform may be used to implement a hypervisor within the virtualization infrastructure 604, where the hypervisor platform has an associated virtual infrastructure management system. The underlying physical machines may comprise one or more distributed processing platforms that include one or more storage systems.

In other implementations of the FIG. 6 embodiment, the VMs/container sets 602 comprise respective containers implemented using virtualization infrastructure 604 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element may be viewed as an example of what is more generally referred to herein as a “processing device.” The cloud infrastructure 600 shown in FIG. 6 may represent at least a portion of one processing platform. Another example of such a processing platform is processing platform 700 shown in FIG. 7.

The processing platform 700 in this embodiment comprises a portion of system 100 and includes a plurality of processing devices, denoted 702-1, 702-2, 702-3, . . . 702-K, which communicate with one another over a network 704.

The network 704 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 702-1 in the processing platform 700 comprises a processor 710 coupled to a memory 712.

The processor 710 may comprise a microprocessor, a microcontroller, an application-specific integrated circuit (ASIC), a field-programmable gate array (FPGA), a central processing unit (CPU), a graphical processing unit (GPU), a tensor processing unit (TPU), a video processing unit (VPU) or other type of processing circuitry, as well as portions or combinations of such circuitry elements.

The memory 712 may comprise random access memory (RAM), read-only memory (ROM), flash memory or other types of memory, in any combination. The memory 712 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM, flash memory or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 702-1 is network interface circuitry 714, which is used to interface the processing device with the network 704 and other system components, and may comprise conventional transceivers.

The other processing devices 702 of the processing platform 700 are assumed to be configured in a manner similar to that shown for processing device 702-1 in the figure.

Again, the particular processing platform 700 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

As indicated previously, components of an information processing system as disclosed herein can be implemented at least in part in the form of one or more software programs stored in memory and executed by a processor of a processing device. For example, at least portions of the functionality for performing data join operations utilizing probabilistic data structures as disclosed herein are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems, IT assets, etc. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. An apparatus comprising:
at least one processing device comprising a processor coupled to a memory;
the at least one processing device being configured:
to receive, at a first compute node from a client, a request to perform a data join operation involving a first data set and a second data set, wherein the first data set is maintained in a first data store managed by the first compute node and the second data set is maintained in a second data store managed by a second compute node;
to obtain, at the first compute node from the second compute node, a probabilistic data structure representing content of the second data set;
to generate, by the first compute node, a third data set by applying the probabilistic data structure to the first data set, the third data set comprising a subset of elements of the first data set; and
to provide, from the first compute node to the client, the third data set.

2. The apparatus of claim 1 wherein the data join operation comprises an exclusion join operation.

3. The apparatus of claim 2 wherein the exclusion join operation comprises a request for elements of the first data set which are not elements of the second data set.

4. The apparatus of claim 1 wherein the subset of elements of the first data set which are included in the third data set comprises the elements of the first data set which are determined, via application of the probabilistic data structure, to not be elements of the second data set.

5. The apparatus of claim 1 wherein the first compute node comprises a first virtual computing instance and the second compute node comprises a second virtual computing instance.

6. The apparatus of claim 1 wherein the first compute node comprises a first microservice and the second compute node comprises a second microservice.

7. The apparatus of claim 1 wherein the probabilistic data structure representing the content of the second data set comprises a filter.

8. The apparatus of claim 7 wherein the filter comprises a Bloom filter.

9. The apparatus of claim 7 wherein the probabilistic data structure is associated with a configurable false positive probability rate.

10. The apparatus of claim 9 wherein obtaining the probabilistic data structure comprises providing, from the first compute node to the second compute node, a value for the configurable false positive probability rate.

11. The apparatus of claim 10 wherein the value for the configurable false positive probability rate is specified in the request to perform the data join operation received from the client.

12. The apparatus of claim 1 wherein obtaining the probabilistic data structure comprises:
receiving, at the first compute node from the second compute node, a serialized data structure; and
deserializing, at the first compute node, the serialized data structure to obtain the probabilistic data structure.

13. The apparatus of claim 1 wherein obtaining the probabilistic data structure comprises:
providing, from the first compute node to the second compute node, a hypertext transfer protocol get request specifying join criteria for the data join operation; and
receiving, at the first compute node from the second compute node, a hypertext transfer protocol response comprising the probabilistic data structure.

14. The apparatus of claim 1 wherein the first data set comprises an inventory of information technology assets in an information technology infrastructure which are eligible for a given software update, the second data set comprises a first subset of the information technology assets in the information technology infrastructure which have already been notified of availability of the given software update, and the third data set comprises a second subset of the information technology assets in the information technology infrastructure which are to be notified of the availability of the given software update.

15. A computer program product comprising a non-transitory processor-readable storage medium having stored therein program code of one or more software programs, wherein the program code when executed by at least one processing device causes the at least one processing device:
to receive, at a first compute node from a client, a request to perform a data join operation involving a first data set and a second data set, wherein the first data set is maintained in a first data store managed by the first compute node and the second data set is maintained in a second data store managed by a second compute node;
to obtain, at the first compute node from the second compute node, a probabilistic data structure representing content of the second data set;
to generate, by the first compute node, a third data set by applying the probabilistic data structure to the first data set, the third data set comprising a subset of elements of the first data set; and
to provide, from the first compute node to the client, the third data set.

16. The computer program product of claim 15 wherein the data join operation comprises an exclusion join operation, the exclusion join operation comprising a request for elements of the first data set which are not elements of the second data set.

17. The computer program product of claim 15 wherein the probabilistic data structure representing the content of the second data set comprises a Bloom filter.

18. A method comprising:
receiving, at a first compute node from a client, a request to perform a data join operation involving a first data set and a second data set, wherein the first data set is maintained in a first data store managed by the first compute node and the second data set is maintained in a second data store managed by a second compute node;
obtaining, at the first compute node from the second compute node, a probabilistic data structure representing content of the second data set;
generating, by the first compute node, a third data set by applying the probabilistic data structure to the first data set, the third data set comprising a subset of elements of the first data set; and
providing, from the first compute node to the client, the third data set;
wherein the method is performed by at least one processing device comprising a processor coupled to a memory.

19. The method of claim 18 wherein the data join operation comprises an exclusion join operation, the exclusion join operation comprising a request for elements of the first data set which are not elements of the second data set.

20. The method of claim 18 wherein the probabilistic data structure representing the content of the second data set comprises a Bloom filter.
